(19) United States
(12) Patent Application Publication
(10) Pub. No.: US 2006/0248461 A1
(43) Pub. Date: Nov. 2, 2006

(54) Socially intelligent agent software

(75) Inventors: Ryota Yamada, Mountain View, CA (US); Hiroshi Nakajima, Kyoto (JP); Kimihiko Iwamura, Santa Clara, CA (US); Ritsuko Nishide, Sunnyvale, CA (US)

Correspondence Address: SUGHRUE MION, PLLC, 401 Castro Street, Ste 220, Mountain View, CA, 94041-2007, US

(73) Assignee: OMRON CORPORATION, Kyoto (JP)

(21) Appl. No.: 11/412,320

(22) Filed: Apr. 26, 2006

Related U.S. Application Data
(60) Provisional application No. 60/676,016, filed on Apr. 29, 2005.

(51) Int. Cl. G06F 3/00

(52) U.S. Cl. 715/706

(57) ABSTRACT

A socially intelligent agent (SIA) platform enables interactions with various different applications, thereby enabling easier programming of various applications and injecting socially intelligent agents thereto. An application adapter is provided to enable interaction between any application and the SIA platform. In operation, the user provides input via the user interface and the input is applied to the application via the application interface. The application processes the input and provides a social event indication to the SIA platform, via the application adapter. The SIA platform then process the social event and output an behavioral response. The motional response is sent to the application via the application adapter. The application processes the behavioral response and, when proper, output appropriate response to a user interface.

This application claims priority from U.S. Provisional Patent Application Ser. No. 60/676,016 filed Apr. 29, 2005, the disclosure of which is incorporated herein by reference in its entirety.

### BACKGROUND

1. Field of the Invention

The subject invention relates to computer programs generating virtual environments having agents acting therein.

2. Description of Related Art

Over the past several years, computers have increasingly promoted collaborative activities between groups of users. The collaboration between users can be a simple as an instant messaging discussion group, or can be a complex engineering design being developed by a group of engineers dispersed at locations around the world. Computer interfaces have matured as well, changing from the primitive text-based user interfaces of the early days of computers to multimedia-rich browser environments, as well as complex virtual environments. For example, virtual environments are used today to provide realistic scenarios to train personnel involved in occupations requiring quick decision-making, such as police work and aircraft and ship piloting. Coupled with the maturation of the user interface has been the trend towards sophisticated multi-user systems that support collaboration amongst a large group of users.

Concurrent with the rise of the Internet, software agents have become a necessary tool to manage the volume and flow of information available to an Internet user. Software agents execute various tasks as required by a particular user, and are guided by their particular programming. For example, a software agent can operate autonomously and, within that autonomous operation, react to certain events, capture and filter information and communicate the filtered information back to a user. A software agent can be designed to control their own activities, and one of skill can easily design software agents that communicate and interact with other software agents.

The types of software agents are only limited by the imagination of a software designer. A software agent can be designed to be a pedagogical agent that has speech capability (Lester, et al 1997) and can adapt their behavior to their environment (Johnson, 1998). A well-designed software agent can respond with cognitive responses, as well as affect, and their outward behavior is adapted to their particular role (Lester and Stone, 1997), (Andre et al, 1998).

An avatar is defined as the “the representation of a user's identity within a multi-user computer environment; a proxy for the purposes of simplifying and facilitating the process of inter-human communication in a virtual world.” (Gerhard and Moore 1998). Within a virtual environment, avatars have a plurality of attractive traits, such as identity, presence and social interaction. Within a virtual world, an avatar is used to establish a user's presence, and they may take on an assumed persona of the user. For example, in a gaming virtual world, a mild mannered accountant may use an avatar with a persona of a mercenary soldier. It is well known that avatars can be aware of each other within a given virtual world. Moreover, an avatar can be under the direct control of its underlying user, or may have a great deal of freedom with respect to its internal state and actions. A group of avatars can initiate and continue social and business encounters in a virtual world and foster the impression that they are acting as virtual agents and have authority derived from the underlying user.

### SUMMARY

The invention has been made in view of the above circumstances and prior art.

Various aspects and advantages of the invention will be set forth in part in the description that follows and in part will be obvious from the description, or may be learned by practice of the invention. The aspects and advantages of the invention may be realized and attained by means of the instrumentalities and combinations particularly pointed out in the appended claims.

In one embodiment of the present invention, a socially intelligent agent (SIA) platform enables interactions with various different applications, thereby enabling easier programming of various applications and injecting socially intelligent agents thereto. Specifically, an application adapter is provided to enable interaction between any application and the SIA platform. A plurality of adapters can be provided to enable interactions with various applications. In operation, the user provides input via the user interface and the input is applied to the application via the application interface. The application processes the input and provides a social event indication to the SIA platform, via the application adapter. The SIA platform then process the social event and output an emotional response. The emotional response is sent to the application via the application adapter. The application processes the emotional response and, when proper, output appropriate response to a user interface, such as a display (image output), game pad (vibration output), etc.

According to another embodiment of the present invention, a virtual environment is provided for one or more socially intelligent agents (SIA's). The environment comprises a scenario environment that receives user inputs and outputs stimulus messages. The stimulus messages are received by a stimulus interpreter, which interprets the stimulus messages and outputs social facts as input events to the socially intelligent agents. The socially intelligent agents, in turn, process the social facts and output one or more emotion response messages as emotion state/desire messages. An emotion manifester receives the emotion state/desire messages output from the socially intelligent agents and converts the emotion state/desire messages into action messages. The scenario environment receives the action messages and converts them into graphical representations of the socially intelligent agents' emotional responses so that the users are able to visually interpret the actions/responses of the socially intelligent agents.

The virtual environment may further comprise a scenario database, coupled to the scenario environment, for providing a cyberspace context that allows the socially intelligent agents to interact with each other. The cyberspace contexts can be quite varied and are limited only by the imagination of the software programmers creating the virtual environment of the application that is coupled to the SIA platform.

An SIA comprises a social response generator coupled to an emotion generator. The social response generator receives and processes an input event. The input event is processed according to a plurality of predefined personality trait indices stored in a personality trait register and a plurality of emotional state indices stored in an emotional state register. Each of the registers is associated with an agent. Subsequent to processing the input event, the social response generator outputs at least one social response message based on the predefined personality trait index that is output from the predefined personality trait register and the emotional state index output from the emotional state register. The social response message is output to an event buffer. The emotion generator captures the social response message from the event buffer, and outputs an emotion response message. The emotion generator creates the emotion response message based on at least one of a personality trait index that is output from the predefined personality trait register, the emotional state index output from the emotional state register and/or the plurality of emotional state values. This embodiment of the present invention may, for example, be realized in computer firmware or electronic circuitry, or some combination of both hardware and firmware.

An agent uses current emotional state index that has predefined thresholds that are indicative of the emotions of neutrality, happiness, sadness and anger. The agent also uses a current confidence index, wherein the confidence level of the agent is represented as a numerical value. In addition, in a virtual environment, agents have to be aware of each other and be able to react to each other as dictated by the emotional states and personality traits. Therefore, the emotional state register of an agent can further comprise at least one or more of an agent interrelationship index, which is used for indicative of the relationship between agents. The agent interrelationship index is used with another agent that receives an input event, with another agent that outputs an emotion response message or with an agent observes an input event or an emotion response message.

An additional refinement of the agents of the present invention is that the social response generator modifies the current state of the emotional state register based on the input event or the output from the predefined personality state register. For example, if an agent is in a virtual environment and the agent responds incorrectly to a particular input event (e.g., a school environment where a student agent gives an incorrect answer in response to a question from a professor agent), the emotional state register may be updated based on an output from the agent personality trait register, as well as the current emotion index in the emotional state register.

With respect to predefined personality trait register, the personality of an agent comprises at least one of an intelligence index, a conscientiousness index, an extraversion index, an agreeableness index and an emotional stability index. Since a human being's personality traits are fairly stable and do not generally change, the personality traits of an agent according to the present invention are predefined in a particular agent's programming and are not affected by the outputs from the social response generator or the emotion generator. The predefined personality trait register may also comprise an agent social status index. The agent social status index is used to define relationships between agents that receive an input event, agents that output an emotion response message and/or agents that observe an input event or an emotion response message. These indices are useful in establishing a social hierarchy between individual agents and/or groups of agents.

As indicated above, an agent comprises an event buffer for storing social response messages. In an embodiment of the present invention, the event buffer comprises a first buffer and a second buffer. The social response messages are sorted into the first and second buffers dependent upon the type of social response message that is output by the social response generator. For example, the social response generator generates an unexpected response flag, which are stored in the first buffer. The social response generator also generates a danger response flag that is stored in the second buffer. In addition, the social response generator generates a sensory input flag, which is stored in the second buffer. In human beings, different responses to external events are active for differing lengths of time. When a person is surprised, that response only lasts a short time. When a person senses danger, however, that response/awareness will likely last until the person no longer perceives a dangerous situation. In the present invention, the differing time lengths for these types of responses are implements with event buffers having different validity lengths. Specifically, a social response message that is stored in the first buffer is maintained for a predetermined first period of time, and a social response message that is stored in the second buffer is maintained for a predetermined second period of time. In the present invention, a social response message that is stored in the first buffer is maintained for a shorter period of time that a social response message stored in the second buffer.

After the social response generator has processed the input event and output a social response message (if dictated by the agent programming) and updated the emotional state register and/or the current emotion index (if dictated by the agent programming), the emotion generator creates and outputs an emotion response message. There are different emotion response messages, and the emotion response messages are output into emotion categories. As with the event buffer, the emotion categories have differing validity lengths. The generated emotion response messages are based on at least one or more outputs from the predefined personality trait register, one or more outputs from the emotional state register and/or the social response message stored in the event buffer.

The emotion categories comprise at least a lasting emotion category, a short-lived emotion category and a momentary emotion category. For the momentary emotion category, its validity length is determined by an unexpected response flag generated by the social response generator. Accordingly, the emotion generator generates an emotion response message for the momentary emotion category that comprises at least a surprise indicator. For the short-lived emotion category, its validity length is determined by a danger response flag or a sensory input response flag generated by the social response generator. The emotion generator generates an emotion response message for the short-lived emotion category that comprises at least indices indicative of disgust or fear. Finally, the emotion generator generates an emotion response message for the lasting emotion category that comprises indices indicative of neutrality, happiness, sadness or anger.

In an alternative embodiment of the present invention, an agent comprises a social response state machine coupled to an emotion state machine. The social response state machine receives and processes an input event. The input event is processed according to a plurality of predefined personality trait indices stored in a personality trait register and a plurality of emotional state indices stored in an emotional state register. Each of the registers is associated with an agent. Subsequent to processing the input event, the social response state machine outputs at least one social response message based on the predefined personality trait index that is output from the predefined personality trait register and the emotional state index output from the emotional state register. The social response message is output to an event buffer. The emotion state machine captures the social response message from the event buffer, and outputs an emotion response message. The emotion state machine creates the emotion response message based on at least one of a personality trait index that is output from the predefined personality trait register, the emotional state index output from the emotional state register and/or the plurality of emotional state indices. This embodiment of the present invention includes all the features of the first embodiment described above with respect to the characteristics and operation of the social response state machine, the emotion state machine, the emotional state register, the personal trait register, the event buffer, the emotion categories, etc.

In another alternative embodiment of the present invention, an article of manufacture, comprising a computer readable medium having stored therein a computer program for a software agent, and further comprising a first and second code portions that are executed on a computer and/or computer system. The first code portion receives and processes an input event. The input event is processed according to a plurality of predefined personality trait indices stored in a personality trait register and a plurality of emotional state indices stored in an emotional state register. Each of the registers is associated with an agent. Subsequent to processing the input event, the first code portion outputs at least one social response message based on the predefined personality trait index that is output from the predefined personality trait register and the emotional state index output from the emotional state register. The social response message is output to an event buffer. The second code portion captures the social response message from the event buffer, and outputs an emotion response message. The second code portion creates the emotion response message based on at least one of a personality trait index that is output from the predefined personality trait register, the emotional state index output from the emotional state register and/or the plurality of emotional state indices. This embodiment of the present invention includes all the features of the first embodiment described above with respect to the characteristics and operation of the first code portion, the second code portion, the emotional state register, the personal trait register, the event buffer, the emotion categories, etc.

As discussed in the background section, agents need a virtual environment for operation. According to another embodiment of the present invention, such a virtual environment would be suitable for a plurality of agents as described above. The environment may comprise a scenario environment that receives user inputs and outputs stimulus messages. The stimulus messages are received by a stimulus interpreter, which interprets the stimulus messages and outputs social facts as input events to the plurality of software agents. The software agents, in turn, process the social facts as discussed above and output one or more emotion response messages. An emotion manifester receives the emotion response messages output from the plurality of agents and converts the emotion response messages into action messages. Finally, the scenario environment receives the action messages and converts them into graphical representations of the software agents' emotional responses so that the users are able to visually interpret the actions/responses of the software agents.

The virtual environment may further comprise a scenario database, coupled to the scenario environment, for providing a cyberspace context that allows the plurality of agents to interact with each other. The cyberspace contexts can be quite varied and are limited only by the imagination of the software programmers creating the virtual environment.

The virtual environment can further comprise a first role database coupled to the stimulus interpreter. The first role database comprises social characteristics used by the stimulus interpreter to create input events that are sent the plurality of software agents. The virtual environment can further comprise a second role database coupled to the emotion manifester. The second role database comprises information used to convert the emotion response messages received from the plurality of software agents into action messages.

In an alternative embodiment, the virtual environment a scenario database, coupled to the scenario environment, for providing a cyberspace context that graphically depicts the interaction between the plurality of software agents based on the action messages received from the emotion manifester. The scenario environment sends a first type of command to the stimulus interpreter, which outputs a stimulus message to the plurality of software agents and forwards the command to the emotion manifester. The scenario environment can also sends a second type of command to the stimulus interpreter, which outputs a stimulus message only to the plurality of software agents.

In another alternative embodiment, the present invention provides an article of manufacture that comprises a computer readable medium having stored therein a computer program. The computer program comprises a first code portion which, when executed on a computer, provides a plurality of software agents. The computer program further comprises a second code portion which, when executed on a computer, provides a scenario environment that receives user inputs and outputs stimulus messages. The computer program further comprises a third code portion which, when executed on a computer, provides a stimulus interpreter that interprets the stimulus messages and outputs social facts as input events to the plurality of software agents. The computer program further comprises a fourth code portion which, when executed on a computer, provides an emotion manifester that receives the emotion response messages output from the plurality of agents and converts the emotion response messages into action messages. The scenario environment receives the action messages and converts them into graphical representations of the software agents' emotional responses.

The above and other aspects and advantages of the invention will become apparent from the following detailed description and with reference to the accompanying drawing figures.

### BRIEF DESCRIPTION OF THE DRAWINGS

The accompanying drawings, which are incorporated in and constitute a part of this specification illustrate embodiments of the invention and, together with the description, serve to explain the aspects, advantages and principles of the invention. In the drawings,

FIG. 1 is a diagram of a socially intelligent agent according to an embodiment of the present invention.

FIG. 2 is a diagram of an emotional state register according an embodiment of to the present invention.

FIG. 3 is a dominance/friendliness diagram used for establishing personality traits.

FIG. 4 is a diagram of a personality trait register according to an embodiment of the present invention.

FIG. 5 depicts a realization of the personality trait register and the emotional state register according to an embodiment of the present invention.

FIG. 6 is a pseudo-code realization of one task executed by the social response generator according to an embodiment of the present invention.

FIG. 7 is a pseudo-code realization of one task executed by the social response generator according to an embodiment of the present invention.

FIG. 8 is a pseudo-code realization of one task executed by the social response generator according to an embodiment of the present invention.

FIG. 9 is a pseudo-code realization of one task executed by the social response generator according to an embodiment of the present invention.

FIG. 10 is a pseudo-code realization of one task executed by the social response generator according to an embodiment of the present invention.

FIG. 11 is a pseudo-code realization of one task executed by the social response generator according to an embodiment of the present invention.

FIG. 12 is a pseudo-code realization of one task executed by the social response generator according to an embodiment of the present invention.

FIG. 13 is a pseudo-code realization of one task executed by the emotion generator according to an embodiment of the present invention.

FIG. 14 is an illustration of a virtual environment for a plurality of socially intelligent agents according to an embodiment of the present invention.

FIG. 15 is a block diagram of a socially intelligent agent according to an embodiment of the present invention.

FIG. 16 is an illustration of a virtual environment according to an embodiment of the present invention.

FIGS. 17A and 17B are flowcharts illustrating the process flow within a socially intelligent agent according to an embodiment of the present invention.

FIG. 18 is an illustration of a virtual environment for a plurality of socially intelligent agents according to an embodiment of the present invention.

FIG. 19 is a block diagram illustrating the connectivity and interaction between an application and the SIA platform according to an embodiment of the present invention.

FIG. 20A is a schematic of an architecture of the SIA platform according to an embodiment of the invention.

FIG. 20B depicts an example of a process followed by each SIA when an application event is received from the environment.

FIG. 20C is an illustration of a virtual environment for a plurality of socially intelligent agents according to an embodiment of the present invention.

FIG. 21A depicts an example of implementation of a socially intelligent agent 210.

FIG. 21B depicts an example of implementation of a socially intelligent agent according to an embodiment of the present invention.

FIG. 22 depicts an example of implementation of the social response model according to an embodiment of the present invention.

FIG. 23 depicts an example of implementation of the categorical emotion model according to an embodiment of the present invention.

### DETAILED DESCRIPTION

Hereinafter, an illustrative, non-limiting embodiment of the present invention will be described in detail with reference to the accompanying drawings.

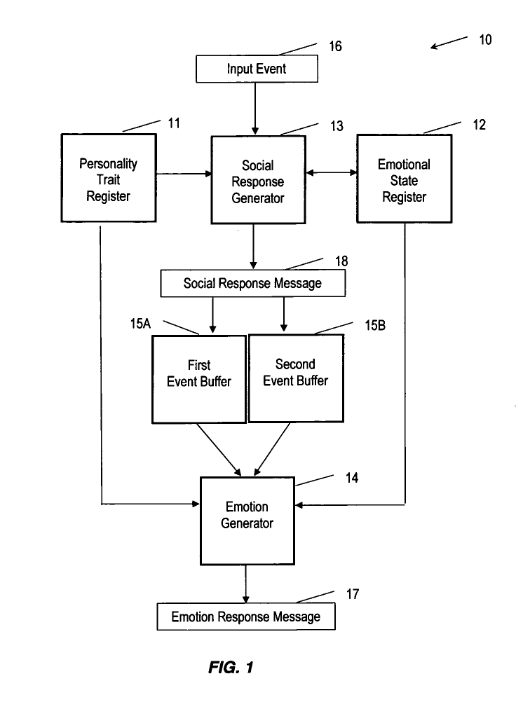

Referring to FIG. 1, in a first embodiment of the present invention, a socially intelligent agent 10 comprises a social response generator 13 coupled to an emotions generator 14. The social response generator 13 receives and processes an input event 16. The input event 16 is processed according to a plurality of predefined personality trait indices stored in a personality trait register 11 and a plurality of emotional state indices stored in an emotional state register 12. Each of the registers is associated with a socially intelligent agent 10. Subsequent to processing the input event 16, the social response generator 13 outputs at least one social response message 18 based on the predefined personality trait index that is output from the predefined personality trait register 11 and the emotional state index output from the emotional state register 12. Depending on its context, the social response message 18 is output to a first event buffer 15A or a second event buffer 15B. The emotion generator 14 captures the social response message 18 from the event buffers 15A or 15B, and outputs an emotion response message 17. The emotions generator 14 creates the emotion response message 17 based on at least one of a personality trait index that is output from the predefined personality trait register 11, the emotional state index output from the emotional state register 12 and/or the plurality of emotional state indices. This embodiment of the present invention may, for example, be realized in computer firmware or electronic circuitry, or some combination of both hardware and firmware.

In the context of the socially intelligent agent 10, states are variable information that each agent has at initialization. For example, states include the emotions of a socially intelligent agent. An emotional state is given to a socially intelligent agent at initialization, and updated according to social rules that are used for the generation of behavior of the socially intelligent agent 10.

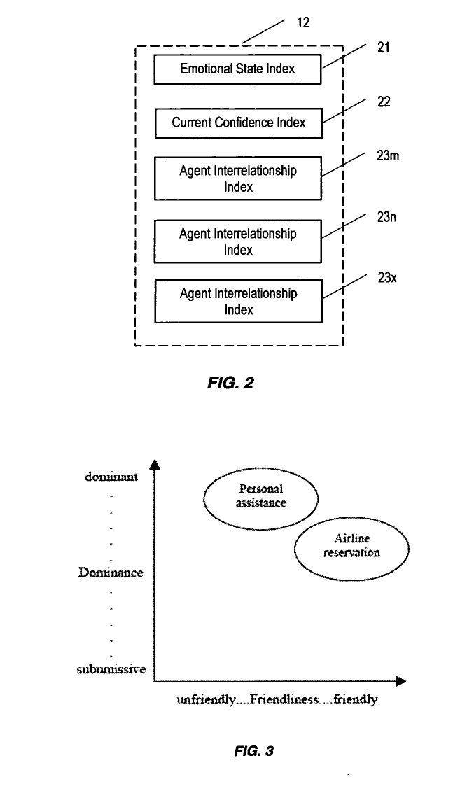

Referring to FIG. 2, a socially intelligent agent 10 uses a current emotional state index 21, wherein predefined thresholds are indicative of neutrality, happiness, sadness and anger. When a socially intelligent agent 10 is instantiated, the initialization process sets the emotional state index 21 to a predefined value. For example, if initial emotional state of the socially intelligent agent is one of neutrality, the emotional state index 21 is set to 0.0. While the socially intelligent agent is active, the emotional state index 21 will range between a maximum and minimum values. For the exemplary embodiment, the emotional state index 21 will contain a real number ranging from −1.0 to 1.0. In the exemplary embodiment, as the emotional state index 21 becomes more positive, i.e., closer to 1.0, the emotional state of the socially intelligent agent 10 will become one of happiness. Conversely, as the emotional state index 21 becomes more negative, i.e., closer to −1.0, the emotion state of the socially intelligent agent 10 degrades into sadness and thence into anger. Of course, within the range of 0.0 to 1.0, there are various thresholds of happiness. For an embodiment of the emotional state index 21, TABLE 1 illustrates the range of possible emotions for the socially intelligent agent 10 and how various thresholds within the emotional state index 21 are associated with the possible emotions.

TABLE 1

| Index Range | Agent Emotional State |
|---|---|
| 0.75 to 1.0 | Extremely Happy |
| 0.41 to 0.7 | Happy |
| 0.11 to 0.4 | Slightly Happy |
| −0.1 to 0.1 | Neutral |
| −0.25 to −0.11 | Slightly Sad/Slightly Angry |
| −0.75 to −0.26 | Sad/Angry |
| −1.0 to −0.76 | Extremely Sad/Extremely Angry |

The ranges illustrated in TABLE 1 are exemplary in natures and can be adapted/changed to suit a particular type of socially intelligent agent. For the negative emotions, TABLE 1 illustrates that a particular range of emotional state index 21 is interpreted for both sadness and anger. For example, if the emotional state index 21 contains a value in the range of −0.25 to −0.11, the emotional state of the socially intelligent agent can be interpreted as slightly sad or slightly angry. The dual interpretations are based on the indices of the predefined personality trait register 11 (See FIG. 4) and will be explained in more detail during the discussion of the emotion generator.

A. Bandura (See Self-efficacy (1994) (V. S. Ramachaudran (Ed.), Encyclopedia of human behavior (Vol. 4, pp. 71-81), New York: Academic Press (Reprinted in H. Friedman [Ed.], Encyclopedia of mental health, San Diego: Academic Press, 1998))) describes self-efficacy (i.e., confidence) as a fundamental psychological construct, defining it as “people's beliefs about their capabilities to produce designated levels of performance that exercise influence over events that affect their lives.” Bandura further explains that perceived self-efficacy exerts influence over the character of emotion experienced when encountering a task. For example, if a person has a low confidence level when encountering a task, that person may become nervous or afraid. This concept fits well within the framework of appraisal theories of emotion discussed earlier. Bandura further discloses that a person boosts their self-confidence by successfully accomplishing tasks. Conversely, failing to accomplish tasks lowers a person's confidence level.

In an embodiment of the present invention, the socially intelligent agent 10 uses a current confidence index 22, wherein the confidence level of the agent is represented as an integer value. For a socially intelligent agent 10 having a neutral confidence state, the current confidence index 22 will be approximately 0.0. If the current confidence index 22 exceeds a predefined threshold (e.g., 0.45), the socially intelligent agent 10 will exhibit confident behavior. For example, a socially intelligent agent 10 having a high positive value in its current confidence index 22 may comment on the current relationship between other agents, or will comment on the behavior of another socially intelligent agent or will act in an assured manner with socially intelligent agents in the context of a virtual environment. Conversely, a socially intelligent agent 10 having a high negative value in its current confidence index 22 (i.e., −0.63) that exceeds a predefined threshold will manifest unconfident behavior. As with the emotional state index, the thresholds of the current confidence index 22 can be manipulated based on the type of the socially intelligent agent that is desired.

In addition, in a virtual environment, socially intelligent agents have to be aware of each other and be able to react to each other as dictated by the emotional states and personality traits. Therefore, the emotional state register 12 of a socially intelligent agent 10 can further comprise at least one or more of an agent interrelationship index 23m, 23n, 23x for another agent that receives an input event 16 and/or that outputs an emotion response message 17. Depending upon the complexity of the social context within a given virtual environment, a socially intelligent agent 10 may comprise one or more agent interrelationship indices in various combinations. For example, if a particular virtual environment is supporting four socially intelligent agents (AGENT1, AGENT2, AGENT3 and AGENT4), each of the agents will have multiple agent interrelationship indices. For example, AGENT1 will have an agent interrelationship index(AGENT2) directed towards AGENT2, an agent interrelationship index(AGENT3) directed towards AGENT3 and an agent interrelationship index(AGENT4) directed towards AGENT4. Of course, the agent interrelationship index 23 can be implemented as individual registers or memory locations, or as an array with an identifier of a particular socially intelligent agent acting as the index into the array. The social response generator 13 can call on these various indices as its programming warrants.

A discussion of the values used in the various interrelationship indices and how they indicate relationships between socially intelligent agents follows. AGENT1 has a neutral relationship with AGENT2, i.e., the agent interrelationship index of AGENT1 for AGENT2 is approximately 0.0. This value is the default value for the agent interrelationship index 23 between two socially intelligent agents. If the AGENT1/AGENT2 interrelationship index becomes more positive, it means that AGENT1 likes AGENT2 and the absolute value of this value represent how much AGENT1 likes AGENT2. In addition, when AGENT1 has an unpleasant relationship with AGENT3, i.e., the AGENT1/AGENT3 interrelationship index is less than 0.0. If the AGENT1/AGENT3 interrelationship index becomes more negative, it means AGENT1 dislikes AGENT3, and the absolute value of the AGENT1/AGENT3 interrelationship index represents how AGENT1 dislikes AGENT3. Of course, AGENT2, AGENT3 and AGENT4 each have their own interrelationship indices with AGENT1, as well as with each other.

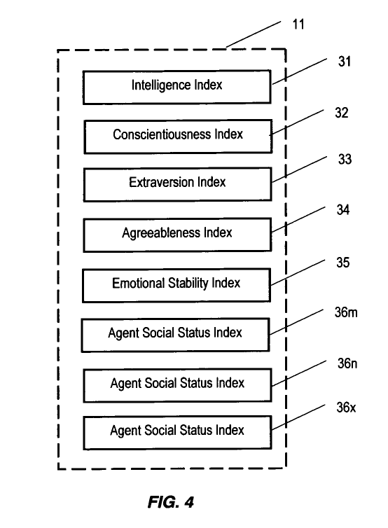

Human beings naturally recognize and respond to the personalities of other individuals. Since an individual's personality is one of their more consistent mental aspects, it is typically used as a predictive indicator of the emotional state and possible behaviors of an individual. Although an individual's personality does not radically transform within a short time intervals, prolonged exposure to a particular environment can induce some change. In the realm of psychology, five indicia are known to characterize some of the major attributes of personality. See D. Moffat, Personality Parameters and Programs, Creating Personalities for Synthetic Actors, Springer (1997). The indicia are openness/intellect, conscientiousness, extraversion, agreeableness and emotional stability. Reeves and Nass claim that friendliness and dominance are two major attributes of personality, especially that of mediated agents. See B. Reeves, and C. Nass, The Media Equation: How People Treat Computers, Television, and New Media Like Real People and Places, CSLI publications and Cambridge University Press, New York, 1996. FIG. 3 depicts a two-dimensional personality space that demonstrates the interrelationship between friendliness and dominance. The personality traits for a personal assistant agent should preferably be dominant and does not need to be overly friendly. For a service type agent, the personality should be friendly and not so dominant so the service agent will be more compliant to the customer's requests. This personality mapping technique is very useful to reduce a potentially large number of design parameters such as rules for selecting action, rules for facial expression, etc.

In the context of the present invention, traits are static information that does not change during a session in a virtual environment. For a socially intelligent agent 10, traits include personality and social status. Referring to FIG. 4, with respect to predefined personality trait register 11, the socially intelligent agent 10 comprises one or more of an intelligence index 31, a conscientiousness index 32, an extraversion index 33, an agreeableness index 34 and an emotional stability index 35. As noted above, in the short term, a human being's personality traits are fairly stable and do not generally change. Thus, the personality traits of a socially intelligent agent 10 according to the present invention are predefined in a particular agent's programming and are not affected by the outputs from the social response generator 13 or the emotions generator 14.

The predefined personality trait register 11 will now be described in greater detail. The intelligence index 31 represents the degree of openness to experience and/or intellect of the socially intelligent agent 10. In the exemplary embodiment, the intelligence index 31 ranges from 0.0 to 1.0. An average socially intelligent agent 10 will have an intelligence index 31 of approximately 0.5. If the intelligence index 31 is greater than 0.5, the socially intelligent agent 10 will be imaginative, curious, creative, adventurous, original, artistic, etc. Conversely, if the intelligence index 31 is less than 0.5, the socially intelligent agent 10 will act in a conventional manner, will avoid the unfamiliar, will be inartistic, will lack imagination, etc.

The conscientiousness index 32 represents the degree of conscientiousness of a socially intelligent agent. In the exemplary embodiment, the conscientiousness index 32 ranges from 0.0 to 1.0. An average socially intelligent agent 10 will have a conscientiousness index 32 of approximately 0.5. If the conscientiousness index 32 is greater than 0.5, a socially intelligent agent will be cautious, disciplined, organized, neat, ambitious, goal-oriented, etc. On the other hand, if the conscientiousness index 32 is less than 0.5, a socially intelligent agent will be unreliable, lazy, careless, negligent, low on need for achievement, etc.

The extraversion index 33 represents the degree of extraversion of a socially intelligent agent. In the exemplary embodiment, the extraversion index 33 ranges from 0.0 to 1.0. An average socially intelligent agent 10 will have an extraversion index 33 of approximately 0.5. If the extraversion index 33 is greater than 0.5, a socially intelligent agent will be talkative, optimistic, sociable, friendly, high in need for stimulation, etc. Conversely, if the extraversion index 33 is less than 0.5, a socially intelligent agent will be quiet, conventional, less assertive, aloof, etc.

The agreeableness index 34 represents the degree of agreeableness of a socially intelligent agent. In the exemplary embodiment, the agreeableness index 34 ranges from 0.0 to 1.0. An average socially intelligent agent 10 will have an agreeableness index 34 of approximately 0.5. If the agreeableness index 34 is greater than 0.5, a socially intelligent agent will be compassionate, caring, good-natured, trusting, cooperative, helpful, etc. On the other hand, if the agreeableness index 34 is less than 0.5, a socially intelligent agent will be irritable, rude, competitive, unsympathetic, self-centered, etc.

The emotional stability index 35 represents the degree of neuroticism and/or emotional stability of a socially intelligent agent. In the exemplary embodiment, the agreeableness index 34 ranges from 0.0 to 1.0. An average socially intelligent agent 10 will have an emotional stability index 35 of approximately 0.5. If the emotional stability index 35 is greater than 0.5, a socially intelligent agent will be relaxed, calm, secure, unemotional, even-tempered, etc. Conversely, if the emotional stability index 35 is less than 0.5, a socially intelligent agent will be anxious, nervous, worrying, insecure, emotional, etc.

The predefined personality trait register 11 may also comprise an agent social status index 36m, 36n, 36x. These indices are useful in establishing a social hierarchy between individual agents and/or groups of agents. In the exemplary embodiment, the agent social status index 36m, 36n, 36x is an integer value that is greater than zero. Each socially intelligent agent will have its own social status index, and each socially intelligent agent can refer to the social status index of other socially intelligent agents. For example, if a socially intelligent AGENT1 wants to refer the social status of socially intelligent AGENT2, AGENT1 can refer to the social status index of AGENT2, i.e., agent social status index(AGENT2). Depending upon the complexity of the social context within a given virtual environment, a socially intelligent agent 10 may comprise one or more agent social status indices in various combinations. Of course, the agent social status index 36 can be implemented as individual registers or memory locations, or as an array with an identifier of a particular socially intelligent agent acting as the index into the array. The social response generator 13 can call on these various indices as its programming warrants.

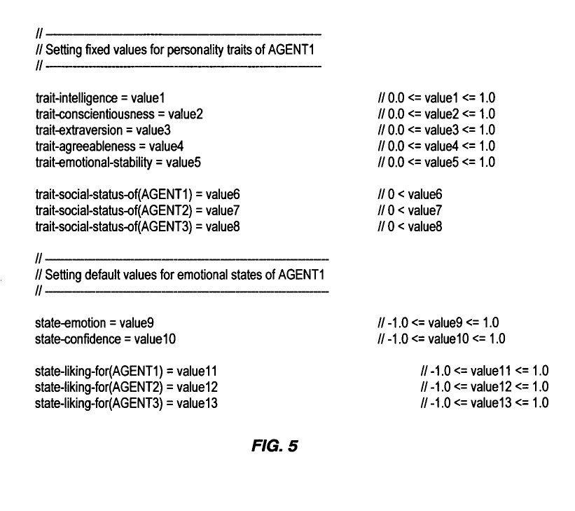

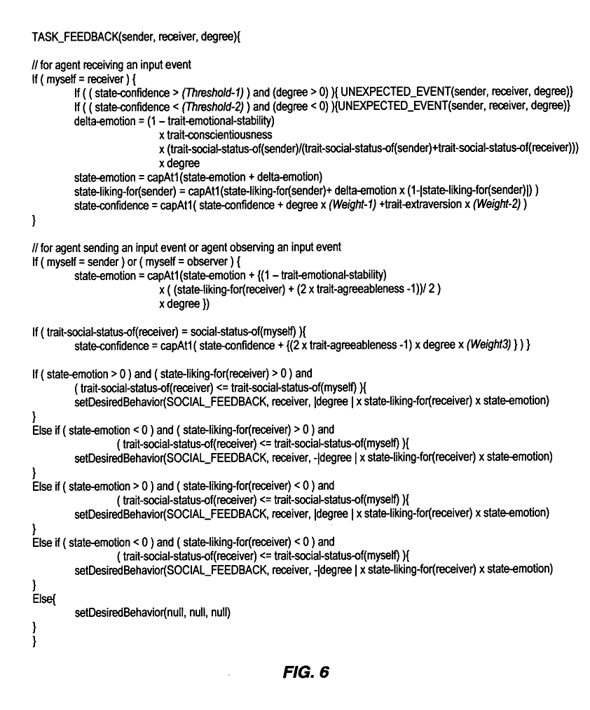

Referring to FIG. 5, an exemplary embodiment of the emotional state register 12 and the predefined personality trait register 11 is illustrated. In this particular exemplary embodiment, the five personality traits, the social status, the emotional state, the confidence level and the interrelationship index for AGENT1 is shown. In addition, the social status index and the interrelationship index for AGENT2 and AGENT3 are shown as well in this exemplary embodiment, which indicates that the socially intelligent agent AGENT1 has a relationship with other socially intelligent agents AGENT2 and AGENT3 and a hierarchy among the socially intelligent agents is present.

An additional refinement of the agents of the present invention is that the social response generator 13 modifies the current state of the emotional state register 12 based on the input event 16 or the output from the predefined personality trait register 11. For example, if a socially intelligent agent 10 is in a virtual environment and the agent responds incorrectly to a particular input event 16 (e.g., a school environment where the agent gives an incorrect answer in response to a question from a professor agent), the emotional state register 12 may be updated based on an output from the agent personality trait register 11, as well as the emotional state index 21 in the emotional state register 12.

Referring to FIG. 6, an exemplary implementation of one of the functions of the social response generator 13 is illustrated. The TASK_FEEDBACK function is defined as a part of social rule, and represents how to process an input event 16 that is related to feedback for some tasks. When a socially intelligent agent 10 has to give feedback for certain tasks towards another socially intelligent agent, the TASK_FEEDBACK function is called.

In the exemplary embodiment, the TASK_FEEDBACK function is divided into two sub-functions that are executed based on how the input event 16 is directed to the socially intelligent agent 10. Specifically, if the socially intelligent agent 10 is the receiver of the input event 16, then the first of the two sub-functions is executed. If the socially intelligent agent 10 is the sender of the input event 16 or is observing the input event 16 (observing in this context means that one socially intelligent agent is aware that another socially intelligent agent is sending/receiving the input event 16, but the observing socially intelligent agent neither receives or sends the input event), then the second of the two sub-functions is executed.

If a socially intelligent agent is receiving an input event 16 that requires feedback, the first sub-function of the TASK_FEEDBACK function is executed. The TASK_FEEDBACK function includes three input parameters: the identifier of the agent that sent the task (sender), the identifier of the agent that is the receives the task, and the degree of the task. The degree parameter is an indicia of the strength of the behavior. The sub-function of the TASK_FEEDBACK function first executes the processes for the event buffer 15 for storing social response messages 18. In the exemplary embodiment, if the agent's current confidence index 22 is above a predefined threshold (i.e., Threshold-1) and the degree of behavior is greater than zero, the function UNEXPECTED_EVENT is called to store an unexpected event indication in the event buffer 15. If the agent's current confidence index 22 is below a predefined threshold (i.e., Threshold-2) and the degree of behavior is less than zero, the function UNEXPECTED_EVENT is called to store an unexpected event indication in the event buffer 15. The Threshold-1 and Threshold-2 factors can be manipulated to fine tune the social responses of the socially intelligent agent. After determining whether to set an unexpected event indication, the first sub-function then updates the emotional state index 21, the current confidence index 22 and the agent interrelationship index 23. First, the sub-function calculates an emotion delta (i.e., delta-emotion in FIG. 6) that is based on the emotional stability index 35, the conscientiousness index 32, the social status index 36 of both the sending agent and the receiving agent, and the degree of behavior. As shown in FIG. 6, the emotional state index 21 (i.e., state-emotion in FIG. 6) is revised based on the current value of the emotional state index 21 and the emotion delta. Next, as shown in FIG. 6, The interrelationship index 23 for the agent that is the sender of the task (e.g., state-liking-for(sender)) is updated as well using the emotion delta value and the current value of the agent interrelationship index 23. Finally, as shown in FIG. 6, the current confidence index 22 is updated using the emotion delta, the current value of the current confidence index 22, the extraversion index 33, the degree of behavior and weighting factors (e.g., Weight-1 and Weight-2). The Weight-1 and Weight-2 weighting factors can be manipulated to fine tune the social responses of the socially intelligent agent.

The TASK_FEEDBACK function uses several sub-functions to accomplish its desired results. In the exemplary embodiment, since several of the personality trait indices and the emotional indices are restricted to values in the range of −1.0 to 1.0, the capAt1 function range limits the calculations performed by the TASK_FEEDBACK function. For example, capAt1(0.3) would returns 0.3, capAt1(1.3) would return 1.0 and capAt1(−1.6) would return −1.0. The sub-function setDesiredBehavior(x, y, z) sets an index for doing behavior identified by parameter x towards another socially intelligent agent identified by y with degree of behavior z. For example, the function call “setDesiredBehavior(SOCIAL_FEEDBACK, AGENT3, 0.5)” means gives social feedback towards an agent with the identifier AGENT3 with degree of behavior equal to 0.5.

The second sub-function of the TASK_FEEDBACK function is called if the socially intelligent agent 10 has sent the input event 16 or is observing the input event 16. First of all, the emotional state index 21 and the current confidence index of the agent are updated in a similar manner as discussed above with respect to an agent that receives an input event 16, although the formulas used are different. Next, the emotional state index 21, the various social status indices and the interrelationship index for the agent receiving the input event 16 are examined. In the exemplary embodiment, different combinations of the emotional state index 21 and the agent social status index 36 of the sending/observing agent, and the interrelationship index 23 and agent social status index 36 of the receiving agent are examined, and based on their results, the sub-function setDesiredBehavior(x, y, z) is called to set an index for a behavior directed to a particular agent. Depending upon the values of the various indices, the giving of social feedback in response to an input event 16 may or may not occur. The invocation of setDesiredBehavior(null, null, null)” clears the buffer for storing the index related to behavior.

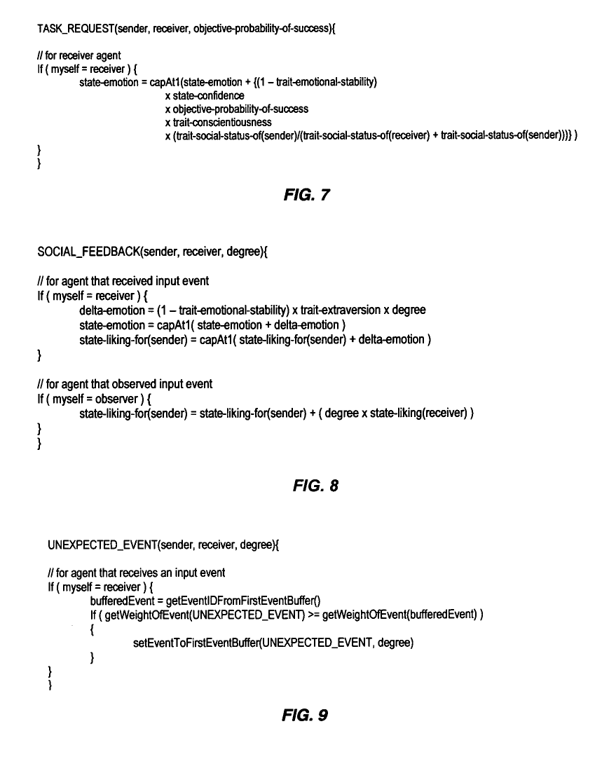

Referring to FIG. 7, an exemplary implementation of another of the functions of the social response generator 13 is illustrated. The TASK_REQUEST function processes an input event 16 related to a task request. When one socially intelligent agent makes a task request to another socially intelligent agent, the TASK_REQUEST function is called. A feature of the invention is that all socially intelligent agents operating within a particular cyberspace context receive the Task_Request. In this manner, it is not only a particular avatar or agent that is aware of the request, but all agents are aware of it and may respond to it. Therefore, TASK_REQUEST function of each agent first determines if the socially intelligent agent is the receiver of an input event 16. If so, the TASK_REQUEST function will update the emotional state index 21 of the agent using the emotional stability index 36, the conscientiousness index 32, the current confidence index 22 and the social status of the sending agent as well as the social status of the receiving agent. In addition, a parameter of the TASK_REQUEST function is an objective probability of success. The objective probability of success parameter is set by the cyberspace context in which the socially intelligent agent is operating. For example, if the objective probability of success parameter is a low real number (i.e., 0.2), then that is an indication that the requested task is difficult. Conversely, if the objective probability of success parameter is a high real number (i.e., 0.89), then the requested task is simple.

Referring to FIG. 8, an exemplary implementation of another of the functions of the social response generator 13 is illustrated. The SOCIAL_FEEDBACK function was referred to earlier in FIG. 6 and was invoked in the context of social feedback. If a socially intelligent agent is to provide social feedback based on emotional and personality indices, then the SOCIAL_FEEDBACK function is called. If an agent that received an input event is invoking the SOCIAL_FEEDBACK function, an emotion delta (e.g., delta-emotion in FIG. 8) is calculated using the emotional stability index 35, the extraversion index 33 and the degree of behavior parameter that is input in the SOCIAL_FEEDBACK function. As shown in FIG. 8, the emotion delta is used to update the emotional state index 21 and the interrelationship index 23 for the sender of the input event 16. If an agent that observed an input event 16 is calling the SOCIAL_FEEDBACK function, then the interrelationship index 23 of the agent that sent the input event 16 is updated using the degree of behavior.

As indicated above, a socially intelligent agent 10 comprises an event buffer 15 for storing social response messages 18. In an embodiment of the present invention, the event buffer 15 comprises a first buffer 15A and a second buffer 15B. The social response messages 18 are sorted into the first and second buffer dependent upon the type of social response message 18 that is output by the social response generator 13. For example, the social response generator 13 generates an unexpected response flag, which is stored in the first buffer 15A. The social response generator 13 also generates a danger response flag that is stored in the second buffer 15B. In addition, the social response generator 13 generates a sensory input flag, which is stored in the second buffer 15B. In human beings, different responses to external events are active for differing lengths of time. When a person is surprised, that response only lasts a short time. When a person senses danger, however, that response/awareness will likely last until the person no longer feels a sense of danger. In the present invention, the differing time lengths for these types of responses are implements with event buffers 15A, 15B having different validity lengths. Specifically, a social response message 18 that is stored in the first buffer 15A is maintained for a predetermined first period of time, and a social response message 18 that is stored in the second buffer 15B is maintained for a predetermined second period of time. In the present invention, a social response message 18 that is stored in the first buffer 15A is maintained for a shorter period of time that a social response message 18 stored in the second buffer 15B.

Referring to FIG. 9, an exemplary embodiment of a function used by the social response generator to set the unexpected response flag is illustrated. The UNEXPECTED_EVENT function first determines if an agent calling this function is an agent that received an input event 16. If so, the UNEXPECTED_EVENT function checks the first buffer 15A to determine if an unexpected response flag is present. The value returned from this interrogation is then compared to the value of the new unexpected response flag. If the weight of the new unexpected response flag is greater than the one currently stored in the first buffer 15A, the new unexpected response flag will be stored in the first buffer 15A, and the value will set based on the degree of behavior. As noted above, if a socially intelligent agent was the receiver of a Social_Event and depending upon the current confidence index 42, the Unexepcted_Event function might be called.

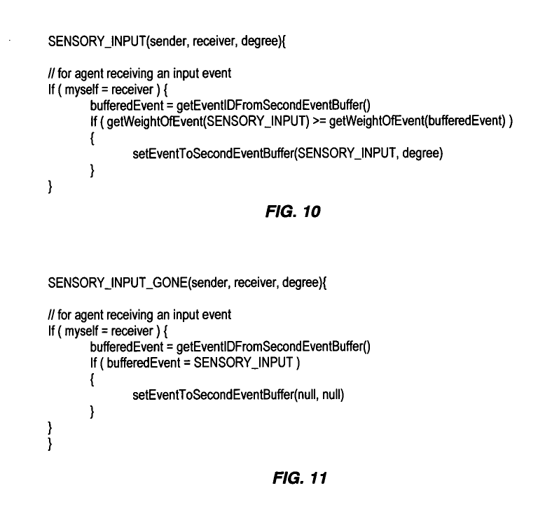

Referring to FIGS. 10 and 11, exemplary functions that support the processing of an input event 16 that is related to sensory input are illustrated. As shown in FIG. 10, the SENSORY_INPUT function determines if the agent calling the function was the receiving agent of an input event. If the agent received an input event 16, then the weight of the new sensory input flag is compared to the weight of the event currently buffered in the second event buffer 15B. In the exemplary embodiment, only the sensory input flag and the danger response flag will be stored in the second event buffer 15B. The weights of the sensory input flag and the danger response flag are predefined and the weight of danger response flag is bigger than that of the sensory input flag. This means that a later-occurring sensory input flag will overwrite a sensory input flag stored in the second event buffer 15B, but the later-occurring sensory input flag cannot overwrite danger response flag stored in there. FIG. 11 illustrates an exemplary embodiment of clearing a sensory input flag. A socially intelligent agent that received the input event will update second event buffer by checking to see if its contents is a sensory input flag. If the stored content is a sensory input flag, the agent will clear the second event buffer 15B.

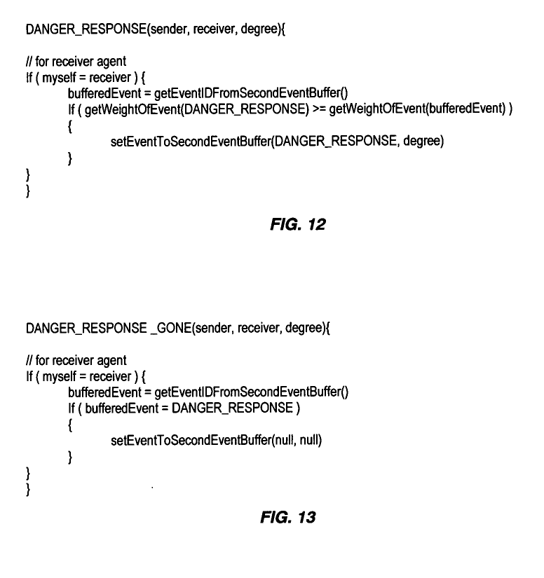

Referring to FIGS. 12 and 13, exemplary functions that support the processing of an input event 16 that is related to a danger response are illustrated. As shown in FIG. 12, the agent calling the DANGER_RESPONSE function determines if the agent has received an input event. If so, the DANGER_RESPONSE function obtains the weight of the social response message 18 currently buffered in the second event buffer 15B. If the weight of the new danger response flag is greater than the social response message 18 currently stored in the second event buffer 15B, the danger response flag is written into the second event buffer 15B. As mentioned previously, the weights of the sensory input flag and the danger response flag are predefined and the weight of danger response flag is bigger than that of the sensory input flag. Therefore, a social response message 18 manifested as a danger response flag will overwrite a social response message 18 manifested as a sensory input flag. FIG. 13 illustrates an exemplary procedure for clearing the danger response flag from the second event buffer 15B.

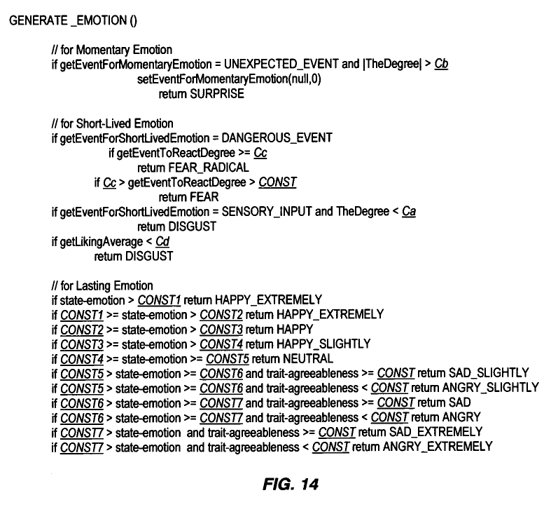

Referring to FIG. 14, after the social response generator 13 has processed the input event 16 and output a social response message 18 (if dictated by the agent programming) and updated the emotional state register 12 and/or the current emotion index (if dictated by the agent programming), the emotions generator 14 creates and outputs an emotion response message 17. There are different emotion response messages 17, and the emotion response messages 17 are output into emotion categories. As with the event buffer 15, the emotion categories have differing validity lengths. The generated emotion response messages 17 are based on at least one or more outputs from the predefined personality trait register 11, one or more outputs from the emotional state register 12 and/or the social response message 18 stored in the event buffer 15.

The emotion categories comprise at least a lasting emotion category, a short-lived emotion category and a momentary emotion category. For the momentary emotion category, its validity length is determined by an unexpected response flag generated by the social response generator 13. Accordingly, the emotions generator 14 generates an emotion response message 17 for the momentary emotion category that comprises at least a surprise value. For the short-lived emotion category, its validity length is determined by a danger response flag or a sensory input response flag generated by the social response generator 13. The emotions generator 14 generates an emotion response message 17 for the short-lived emotion category that comprises at least a disgust value or a fear value. Finally, the emotions generator 14 generates an emotion response message 17 for the lasting emotion category that comprises at least a neutrality value, a happiness value, a sadness value or an anger value.

More specifically, in FIG. 14, there is shown three exemplary functions that the emotion generator 14 uses to generate emotions. The first function illustrates the generation of a momentary emotion. As described earlier, in the exemplary embodiment of the present invention, the emotion of surprise is defined as a momentary emotion. For a particular socially intelligent agent, if the value in the first event buffer 15A is equal to an unexpected event and the degree of the unexpected event is above a particular threshold (Cb), then the first event buffer 15A is cleared and the Surprise message is returned in the short-lived emotion category. The threshold Cb can be adjusted as necessary to fine tune the emotional response of the socially intelligent agent.

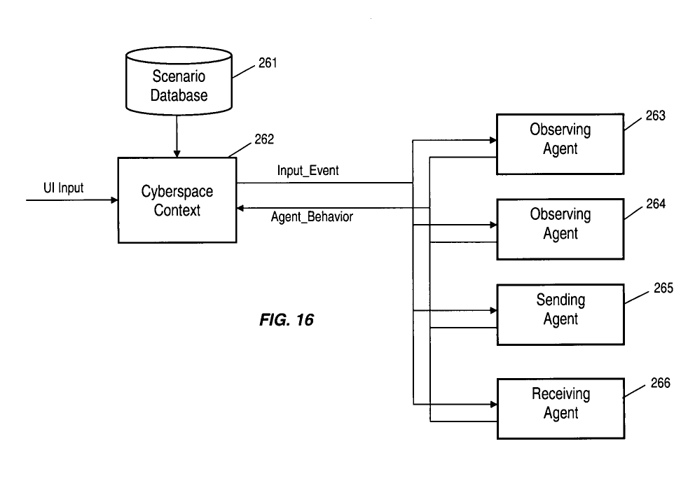

With respect to the category of short-lived emotions, in the exemplary embodiment of the present invention, the emotional responses of fear and disgust are defined. As shown in FIG. 16, the value that is contained in the second event buffer 15B is examined to determine if it is a Dangerous_Event or a Sensory_input value. If the value in the second event buffer 15B is a Dangerous_Event, then the degree of the value in the second event buffer 15B is checked to determine if the Fear or Fear_Radical messages should be output in the short-lived emotion category. The constants Cc and Ce are used to make this determination, and these constants can be adjusted to obtain the desired emotional response from the socially intelligent agent. If the value in the second event buffer 15B is a Sensory_input, then the degree of the value in the second event buffer 15B is examined against the constants Ca and Cd to determine whether the Disgust message should be output to the short-lived emotion category. In the exemplary embodiment, the constants Ca through Ce are defined as follows in Table 2:

TABLE 2

| | |
|---|---|
| Ca | 0.5 |
| Cb | 0.5 |
| Cc | 0.8 |
| Cd | −0.9 |
| Ce | 0.5 |

For the lasting emotion category, the emotion generator 14 examines the emotional state index 41 and the agreeableness index 64 of the socially intelligent agent to output the emotions of neutrality, sadness, happiness or anger. The emotions of sadness, happiness and anger are further shaded with the modifiers of slightly and extremely. In the exemplary embodiment of the emotion generator 14, the various constants are defined as follows in Table 3:

TABLE 3

| | |
|---|---|
| CONST | 0.0 |
| CONST2 | (2.0/7.0)*6.0 − 1.0 |
| CONST3 | (2.0/7.0)*5.0 − 1.0 |
| CONST4 | (2.0/7.0)*4.0 − 1.0 |
| CONST5 | (2.0/7.0)*3.0 − 1.0 |
| CONST6 | (2.0/7.0)*2.0 − 1.0 |
| CONST7 | (2.0/7.0)*1.0 − 1.0 |

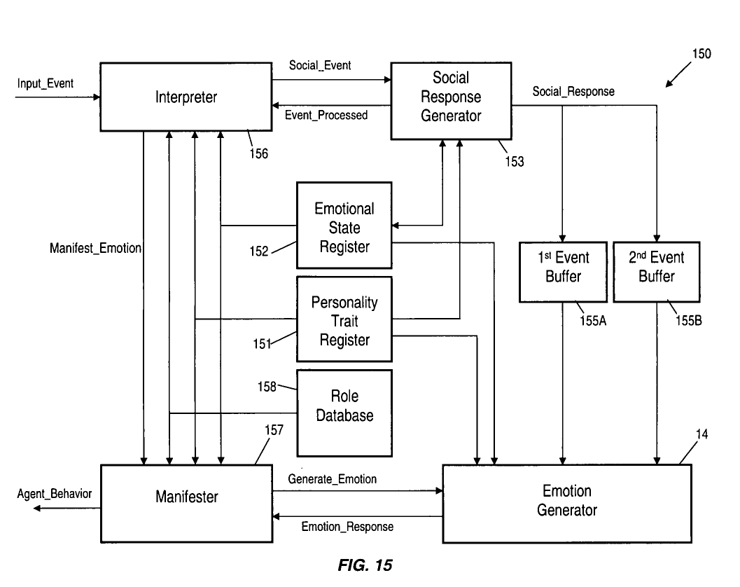

Referring to FIG. 15, in another embodiment of the present invention, a socially intelligent agent 150 comprises a social response generator 153 coupled to an emotion generator 154. The social response generator 153 receives and processes a Social_Event message. The social response generator 153 processes the Social_Event message according to a plurality of predefined personality trait indices stored in a personality trait register 151 and a plurality of emotional state indices stored in an emotional state register 152. The personality trait register 151 and the emotional state register 152 are not global in nature, in that only the socially intelligent agent 150 associated with those registers can access them. Subsequent to the processing of the Social_Event message, the social response generator 153 outputs at least one Social_Response message based on the predefined personality trait indices that is output from the predefined personality trait register 151 and the emotional state index output from the emotional state register 152. Depending on its context, the Social_Response message is output to a first event buffer 155A or a second event buffer 155B. The emotion generator 154 captures the Social_Response message from the event buffers 155A, 155B, and outputs an Emotion_Response message. The emotion generator 154 creates the Emotion_Response message based on at least one of a personality trait index that is output from the predefined personality trait register 151, the emotional state index that is output from the emotional state register 152 and/or the plurality of emotional state indices.

The socially intelligent agent 150 further comprises an interpreter 156, which receives an Input_Event message. The cyberspace context that the socially intelligent agent 150 is operating within generates an application dependent task event according to cyberspace context and sends the application dependent task event to all the socially intelligent agents attached to the context. For example, in a cyberspace context involving a plurality of socially intelligent agents as students and an additional socially intelligent agent acting as a professor, a typical application dependent task event might be PROFESSOR_CALL_STUDENT, which is sent to all the socially intelligent agents. When the interpreter 156 receives an application dependent task event as an Input_Event message, the application dependent task event is processed based on information from the emotional state register 152, the personality trait register 151 and a role database 158, which contains social characteristic information. Alternatively, the interpreter 156 forwards the Input_Event message to the social response generator 153 as a Social_Event message without any further processing using information from the emotional state register 152, the personality trait register 151 and a role database 158. After the social response generator 153 has processed the Social_Event message received from the interpreter 156, the social response generator 153 sends an Event_Processed flag to the interpreter 156.

The socially intelligent agent 150 further comprises a manifester 157 that coordinates the manifestation of the socially intelligent agent's emotional response to the Social_Event message. After receiving the Event_Processed flag from the social response generator 153, the interpreter 156 outputs a Manifest_Emotion flag to the manifester 157 to begin the process of manifesting the socially intelligent agent's emotional response. Based on the social characteristics in the role database 158, the manifester 157 sends a Generate_Emotion flag to the emotion generator 154. The emotion generator 154 uses information from the emotional state register 152, the personality register 151 and the event buffers 155A, 155B to generate the socially intelligent agent's emotional response (if one is required) to the Social_Event message. It might be, based on the social characteristics in the role database 158, that no emotional response is required and the manifester 157 does not issue a Generate_Emotion flag to the emotion generator 154. If the manifester 157 issues a Generate_Emotion flag, the emotion generator 154 outputs an Emotion_Response message to the manifester 157 based on information from the emotional state register 152, the personality register 151 and the event buffers 155A, 155B. The manifester 157 uses the Emotion_Response message, plus information from the emotional state register 152, the personality register 151 and the role database 158 to formulate an Agent_Behavior message that is indicative of the socially intelligent agent's response to a Social_Event message.

Referring to FIG. 16, a typical cyberspace context with multiple socially intelligent agents is illustrated. The socially intelligent agent 265 is the sending agent of an Agent_Behavior message that is processed by the cyberspace context 262. The socially intelligent agent 266 is an agent that is the recipient of an Input_Event message from the cyberspace context 262. The socially intelligent agents 263, 264 are observing agents, in that their social responses are based on the Input_Event messages or Agent_Behavior messages that are sent to all agents, but are not specifically targeted to them, i.e., agents 263, 264. The cyberspace context 262 is coupled to a scenario database 261, which sends information that forms the cyberspace context. For example, if the cyberspace context 262 was a university classroom for a biology class, the scenario database 261 might contain a lecture on bacteria, which is then followed by a quiz of the “students” (i.e., socially intelligent agents) attending the lecture.

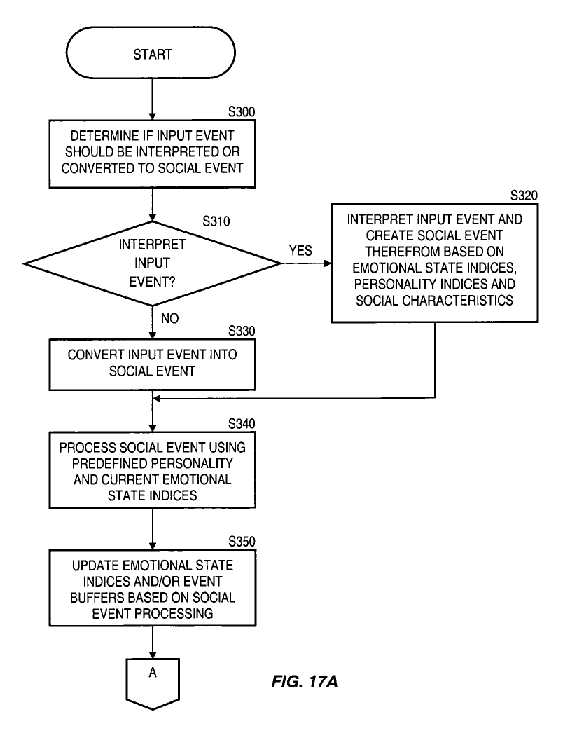

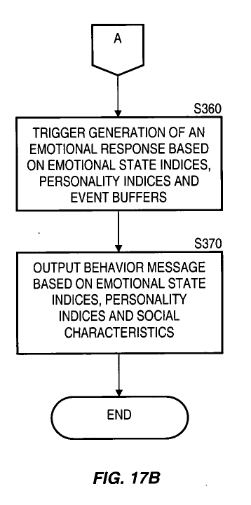

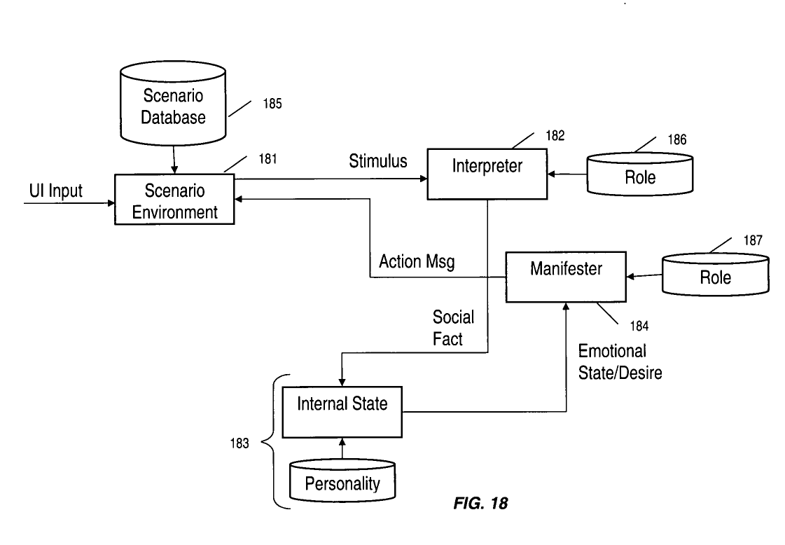

Referring to FIGS. 17A-17B, a flowchart illustrating the process flow within a socially intelligent agent is illustrated. At S300, a determination is made whether an Input_Event message should be interpreted using information from the emotional state indices, the personality trait indices and social characteristics, or should be converted into a Social_Event message. If the determination is positive, then, at S320, the Input_Event message is interpreted using emotional state information, personality traits and social characteristics. As shown in FIG. 15, this information would reside in the emotional state register 152, the personality trait register 151 and the role database 158, respectively. If the determination is negative, then, as S330, the Input_Event message is converted into a Social_Event message without any interpretation using the emotional state indices, the personality trait indices and social characteristics. At S340, the Social_Event message is processed using the emotional state indices and the personality trait indices. Again, as shown in FIG. 15, this information would reside in the emotional state register 152 and the personality trait register 151. At S350, after the Social_Event message has been processed, the emotional state indices are updated, along with the event buffers, if necessary. The event buffers are the first and second event buffers, 155A and 155B, illustrated in FIG. 15. Subsequent to the updating of the emotional state indices and the event buffers, at S360, the generation of an Emotion_Response message is triggered based on the emotional state indices, the personality trait indices and the event buffers. Following the generation of the Emotion_Response message, at S370, a behavior message is output based on the emotional state indices, the personality trait indices and the stored social characteristics.

In the context of the socially intelligent agent 150, states are variable information that each agent has at initialization. For example, states include the emotions of a socially intelligent agent. An emotional state is given to a socially intelligent agent at initialization, and updated according to social rules that are used for the generation of behavior of the socially intelligent agent 150.

As discussed in the background section, agents need a virtual environment for operation. According to another embodiment of the present invention, such a virtual environment would be suitable for one or more socially intelligent agents as described above. Referring to FIG. 18, the environment may comprise a scenario environment 181 that receives user inputs and outputs stimulus messages. The stimulus messages are received by a stimulus interpreter 182, which interprets the stimulus messages and outputs social facts as input events to the one or more socially intelligent agents 183. The socially intelligent agents 183, in turn, process the social facts as discussed above and output one or more emotion response messages as emotion state/desire messages. An emotion manifester 184 receives the emotion state/desire messages output from the one or more socially intelligent agents 183 and converts the emotion state/desire messages into action messages. The scenario environment 181 receives the action messages and converts them into graphical representations of the socially intelligent agents' emotional responses so that the users are able to visually interpret the actions/responses of the socially intelligent agents 183.

The virtual environment may further comprise a scenario database 185, coupled to the scenario environment 181, for providing a cyberspace context that allows the socially intelligent agents 183 to interact with each other. The cyberspace contexts can be quite varied and are limited only by the imagination of the software programmers creating the virtual environment.

The virtual environment can further comprise a first role database 186 coupled to the stimulus interpreter 182. The first role database 186 comprises social characteristics used by the stimulus interpreter 182 to create input events that are sent to the socially intelligent agents 183. The virtual environment can further comprise a second role database 187 coupled to the emotion manifester 184. The second role database 187 comprises information used to convert the emotion states/desires received from the socially intelligent agents 183 into action messages.

Referring to FIGS. 18 in further detail, the virtual environment comprises a scenario database 185, coupled to the scenario environment 181, for providing a cyberspace context that graphically depicts the interaction between the socially intelligent agents 183 based on the action messages received from the emotion manifester 184. The scenario environment sends a first type of command to the stimulus interpreter 182, which outputs a stimulus message to the socially intelligent agents 183 and forwards the command to the emotion manifester 184. This first type of command is based upon a user input that is inputted into the scenario environment 181. This command also incorporates a response mechanism, whereby the socially intelligent agents 183 respond back to the emotion manifester 184, which outputs the result of the command back to the scenario environment 181 as action messages. The scenario environment 181 converts the action messages into graphical representations of the socially intelligent agents' emotional responses so that the users are able to visually interpret the actions/responses of the socially intelligent agents 183. The scenario environment 181 can also send a second type of command to the stimulus interpreter 182, which outputs a stimulus message only to the socially intelligent agents 183. There is no response from the socially intelligent agents 183 in response to this type of command.

In another alternative embodiment, the present invention provides an article of manufacture that comprises a computer readable medium having stored therein a computer program. The computer program comprises a first code portion which, when executed on a computer, provides a socially intelligent agents 183. The computer program further comprises a second code portion which, when executed on a computer, provides a scenario environment 181 that receives user inputs and outputs stimulus messages. The computer program further comprises a third code portion which, when executed on a computer, provides a stimulus interpreter 182 that interprets the stimulus messages and outputs social facts as input events to the socially intelligent agents 183. The computer program further comprises a fourth code portion which, when executed on a computer, provides an emotion manifester 184 that receives the emotion response messages output from the socially intelligent agents 183 as emotion state/desire messages and converts the emotion state/desire messages into action messages. The scenario environment 181 receives the action messages and converts them into graphical representations of the socially intelligent agents' emotional responses so that the users are able to visually interpret the actions/responses of the socially intelligent agents 183.

As can be understood, according to the embodiments described herein, including the embodiment depicted in FIGS. 1 and 18, when the socially intelligent agent is an avatar of the user, the input of the user to the socially intelligent agents are akin to instructions for specific actions or response. However, the manner in which the socially intelligent agent executes the action or response may vary depending on the personality and internal state of the agent—which is outside of the control of the user once the original selection of personality is made. For example, if the socially responsible agent is an avatar in a classroom scenario and a question is directed to the avatar, the user may direct the avatar to provide a selected answer, but the manner in which the avatar elects to convey the answer to the classroom teacher will depend on the personality and state of the avatar. In the case where the avatar, for example, has a high extraversion index value and a high current confidence index value, the avatar may loudly shout: “I know, I know, it's XYZ!” On the other hand, if those values are low, the avatar may utter: “well, I think it may be XYZ. Is it?” In this manner, it can be understood that the various embodiments of the invention provides emotional responses which correlates to the character and emotional state of the agent.

In a similar manner, other intelligent agents participating in the scenario environment can also participate according to their personality traits and emotional state even if no user provides input to these agents. For example, in the classroom environment exemplified above, other agent may be present, some of which may be avatars of other users, while others just present without being an avatar of a user. Assuming that the avatar that answered the question provided a wrong answer. An intelligent agent present in the environment and having a high extraversion index value, high confidence index value, and negative agent interrelationship to the answering avatar may, without any input from a user, turn to the avatar and exclaim: “this is wrong! You have no idea what you are talking about!” On the other hand, another agent having a high agreeableness index and positive agent interrelationship to the answering avatar, may try to comfort the answering avatar without any input from a user by stating: “it's ok, you'll probably get the next one right.” Here again, it can be seen that the various embodiments of the invention provides emotional responses which correlates to the character and emotional state of the agent, even when no input is provided by users.

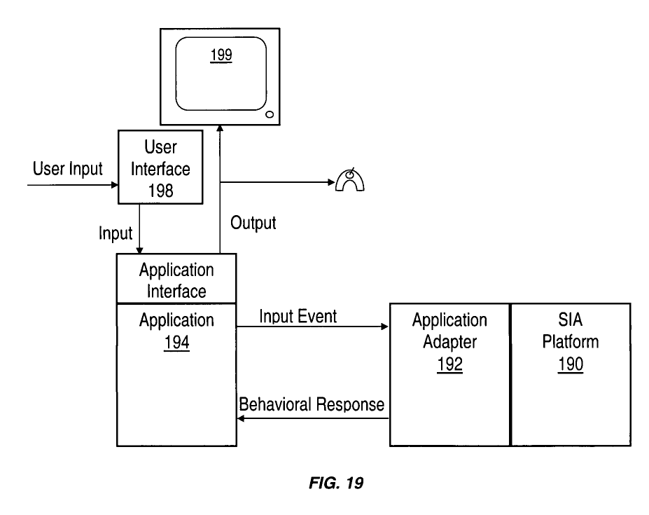

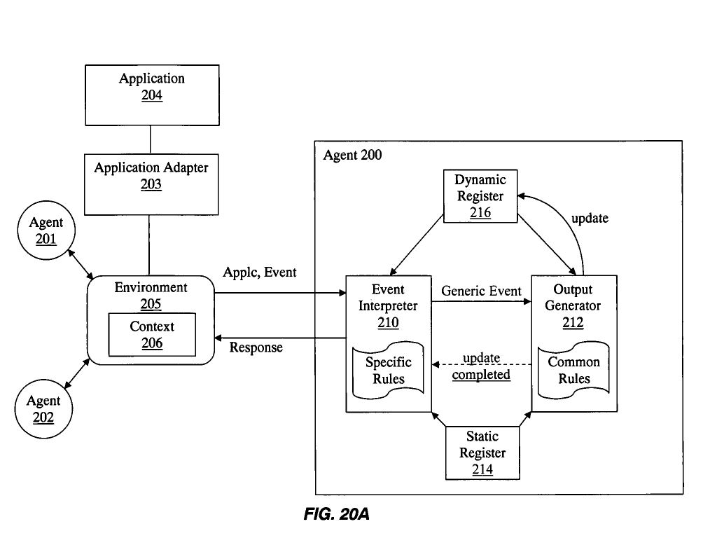

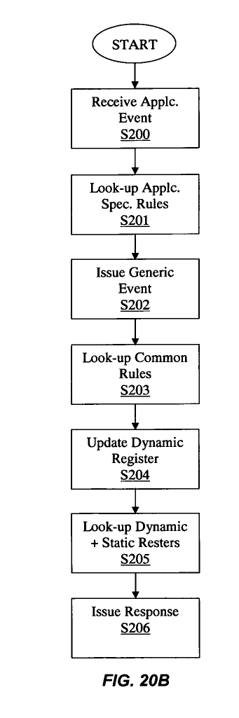

FIG. 19 depicts an embodiment of the invention wherein a socially intelligent agent platform enables interactions with various different applications, thereby enabling easier programming of various applications and injecting socially intelligent agents thereto. Specifically, an application adapter 192 is provided to enable interaction between application 194 and SIA platform 190. While only one application adapter 192 and one application 194 are depicted, it should be understood that a plurality of adapters can be provided to enable interactions with various applications. In operation, the user provides input via the user interface 198. The input is applied to application 194 via the application interface 196. The application processes the input and provides an input event indication to the SIA platform 190, via the application adapter 192. Either the application adapter 192, or a routine within the SIA platform 190 converts the input event into a social event. The SIA platform then process the social event according to any of the inventive methods described herein, and output a behavioral response, e.g. an emotional response. The behavioral response is sent to the application 194 via the application adapter 192. The application 194 processes the behavioral response and, when proper, output appropriate response to a user interface, such as a display 199 (image output), game pad 191 (vibration output), etc.

The advantages of the embodiment of FIG. 19 can be understood from the following. Application 194 may include several actors/agents designed by the designer of the application 194. For example, if the application is a virtual classroom, the actors may be a teacher and a few students; if the application is a battle-type video game the actors may be a few soldiers on the “good side” and a few on the “bad side”, wherein at one or both sides the actors may have different ranks; if the application is an electronic board game, the actors may be a few players of the board game, etc. The designer of the application designs the appearance of these actors and the environment and goal of the application. However, the designer need not concern with the emotional and social aspects of the actors' behavior. Rather, when a session of the application is initialized, the user may select from the application the desired actor and actor appearance the user wishes to be the avatar and any other actors. When the application is coupled to the SIA platform 190 via application adapter 192, each actor in the application session has an SIA assigned to it in the SIA platform, and the user may also select particular personality traits for the avatar and any other actors having an SIA assigned to them. In this manner, every actor participating in the session of the application has an appearance and mission goals dictated by the application 194, and a particular SIA having selected character traits associated therewith in the SIA platform. Additionally, each SIA assigned to an actor in the application also maintains emotional states registers for the actor and provides emotional output in response to social event input. As can be understood, using this architecture, when the actor in the application perceives an event, the event is sent to the assigned SIA in the SIA platform 190, via the adapter 192. The assigned SIA then process the event and outputs an behavioral response that is sent to the application 194 via the adapter 192. Application 194 then executes an actor action based on the rules specified in the application and the behavioral response obtained from the SIA platform 190.

As can be seen from the above description, the SIA platform can be used by many different applications. Additionally, designers of applications need not “re-design” or implement a social response engine for their particular application. Rather, designers of the application may focus on the particular graphics and scenarios of the application, and simply couple to the SIA platform via an adapter to implement behavioral responses of actors within the application.

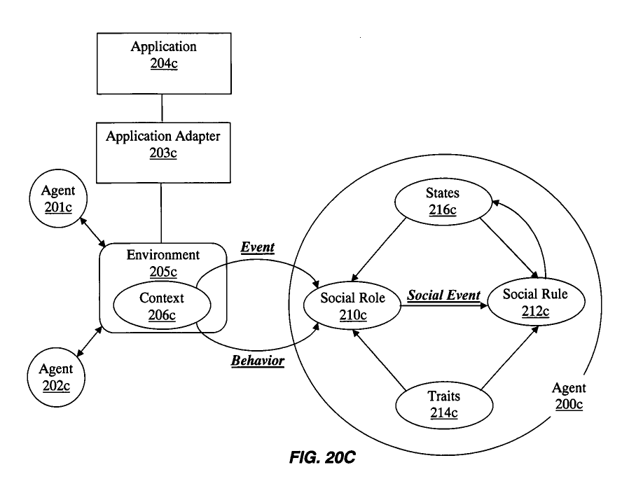

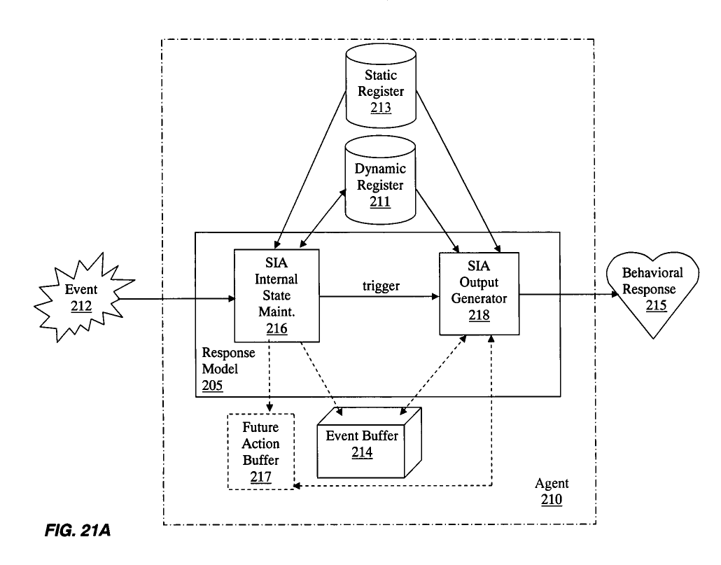

FIG. 20A is a schematic of architecture of the SIA platform according to an embodiment of the invention. The SIA platform generates environment 205, which enables communication among the various agents, 200, 201, and 202, and the application 204 via the application adapter 203. In FIG. 20A three agents are shown, although this architecture can support as many agents as necessary for the application. The context 206 includes data relating to the object and process or flow of the application. For example, if the application is a virtual classroom, the context would include the structure of the lesson, the rules of the lesson, and information shared in the virtual environment, such as answers provided by other agents.

When the application 204 generates an event, the event is sent to all of the agents. The structure of each agent is similar to that shown for agent 200. Each agent has application specific rules stored in the event interpreter 210. The application specific rules are written to be specific to each application 204. Each agent also has common rules listed in the output generator 212, which are used for each event from each application and are common to all applications. That is, the common rules are written by the entity generating the SIA platform and are static for all applications, while the application specific rules may be written by the entity programming the application and change from application to application. One function of the event interpreter 210 is to receive an application event, and determine which generic event is most appropriate to issue in view of the received application event. That is, each agent has a list of generic events. The list of generic events is normally static and does not change between applications. The event interpreter 210 uses the application event to determine which generic event to issue. When the output generator 212 receives a generic event, it looks up the status of the dynamic register 216, the static register 214 and uses the common rules to provide an update to the dynamic register 216. The event interpreter 210 then looks up the entries in the updated dynamic register 216 and the entries in the static register 214 and issues a response based on these entries. It should be appreciated that for a beneficial operation of the embodiment of FIG. 20A, it is contemplated that event interpreter 210 may not update the dynamic register 216. Such function is relegated only to the output generator 212. Only, when the output generator completes its updating function, it may issue an update completed signal to the event interpreter 210, as shown by the broken arrow in FIG. 20A. Alternatively, this signal is not issued, as the sequence may be controlled simply by the sequence of the process, as shown in FIG. 20B.

FIG. 20B depicts an example of a process followed by each SIA when an application event is received from the environment 205. In general, the process follows the major functions of receive input, update internal state, and generate output. In step S200, the application event is received. In step S201 the SIA looks up the application specific rules and uses these rules to issue a generic event in step S202. The SIA then look-up the common rules in step S203, and uses these rules to update the dynamic register in step S204. In step 205 the SIA uses the entries in the dynamic and static registers to determine what response to issue in step 206.

FIG. 20C schematically depicts the structure of the SIA platform according to a specific embodiment of the invention suitable for use with the embodiment shown in FIG. 19. The SIA platform is a multi-agent system that generates as many agents 200C, 201C, 202C as needed for each session of an application 204C. The platform also generates the environment 205C and the context 206C within the environment. The environment 205C is a hub for communication and interactions between the agents. In the illustrated example, each agent has personality (traits) 214C, emotions (states) 216C, social role 210C, and social rules 212C associated with it, as shown for agent 200C. In this example, traits 214C designate the personality and social status of the agent and are static and independent of the application. Traits 214C are established when the agent 200C is created and the data of the traits 214C does not change during a run session of the application 204C. While Traits 214C is static information within a session, states 216C may vary throughout the run time of the application. States 216C designate the emotions and desires of the agent 200C and are independent of the application 204C. States 216C are created for each agent individually and are continuously updated pursuant to social rules 212C. Social roles 212C are a set of rules for generating behaviors of agents in response to social events by referencing their individual traits 214C and states 216C. The response may be explicit, such as speaking or displaying facial expression, or implicit, such as creating an atmosphere. This response is defined herein as a social event, which can be perceived by all socially intelligent agents via the environment 205C, and may cause a social effect to other agents. Social roles 210C are defined for each agent with respect to the application 204C. Taking the virtual classroom example, various social roles 210C can be set for a principal, a teacher, and the students. In this example, all agents acting as students receive the same social role parameters. The manner in which a social event affects an agent is defined by the social rules 212C for originating, receiving and observing agents. Social rules 212C are defined independently of the application 204C, so that in designing the application no effort is made to define social behavior, which will be supplied when the application 204C interfaces to the SIA platform. Therefore, the social rules 212C are designed using social science theory and can be accessed and used by various different application where social interaction is advantageous, such as virtual classroom, video games, etc. The social rules 212C are used to update the variables of the agents' states 216C, for originating, receiving and observing agents. Referring to the previous examples, social rules 212C that are applicable to a teacher and students in a virtual classroom environment are equally applicable to a commander and his troops in a virtual video game environment.

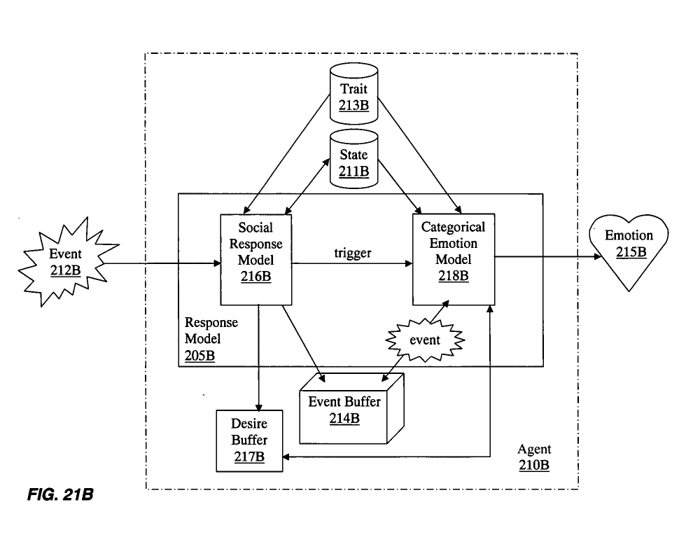

FIG. 21A depicts an example of implementation of a socially intelligent agent 210. The major elements of the SIA agent 210 are a response model 205, a static register 213 and a dynamic register 211. In this particular embodiment, the response model 205 includes an internal state maintenance engine 216 and an output generator 218. When an event is detected by the agent 210, the internal state maintenance engine 216 perform the appropriate maintenance, including updating the entries in the dynamic register 211. In this example, when the internal maintenance is completed, the internal maintenance engine 216 issues a trigger signal to the output generator 218. The output generator then queries the entries in the static register 213 and dynamic register 211, and issues an appropriate output response 215 that would manifest the behavior of the agent 210. In this example, the response 218 may have a validity duration. The validity duration may be determined by, e.g., a field entry in the trigger signal sent from the internal state maintenance engine 216. The output generator then uses this entry to affect the validity period of the response 215. According to another embodiment (shown in broken lines), the internal state maintenance engine 216 determines the validity period and uses an event buffer 214 to indicate the period to the output generator 218. That is, the internal maintenance engine 216 maintains the entries in the event buffer 214 and the output generator queries the entries in the event buffer 214 to determine when to change the response 215.

Another optional feature shown in FIG. 21A in broken lines is the future action buffer 217. According to this feature, the agent 210 may determine that a future action should be taken if specified conditions are met. Under such a situation, the internal maintenance engine 216 updates the future action buffer 217 to indicate that a future action may be taken depending on conditions. Then, when the output generator 218 receives a trigger from the internal state maintenance 216, in addition to checking the entries in the static and dynamic registers, 211 and 213, the output generator 218 also checks the future action buffer 217 to see if the conditions have been met for the future action. If so, the output generator 218 issues an output response 215 to manifest the future action.

FIG. 21B depicts an example of implementation of a socially intelligent agent 210B. As noted above, the agents are designed as autonomous agents and may perform tasks for or in substitute of the user. In this implementation, the agents are aware of each other, of the virtual environment and of the context of the application. Consequently, each agent can be an event sender, an event receiver, or an event observer, within the particular context. The agent 210B is implemented using an event buffer 214B, a social response model 216B, a categorical emotion model 218B, trait register 213B, and state register 211B. When an event is communicated via the environment, the agent 210B operates to issue an emotion response 215B that will be conveyed to the application. In this particular example, three types of events are considered: task request event, task feedback event, and social feedback event. Also, in this specific example, each event consists of an event identifier, event source, event destination, and event degree. As noted above, agents that are not event source or event destination are also aware of the event and may also generate an behavioral response 215B.

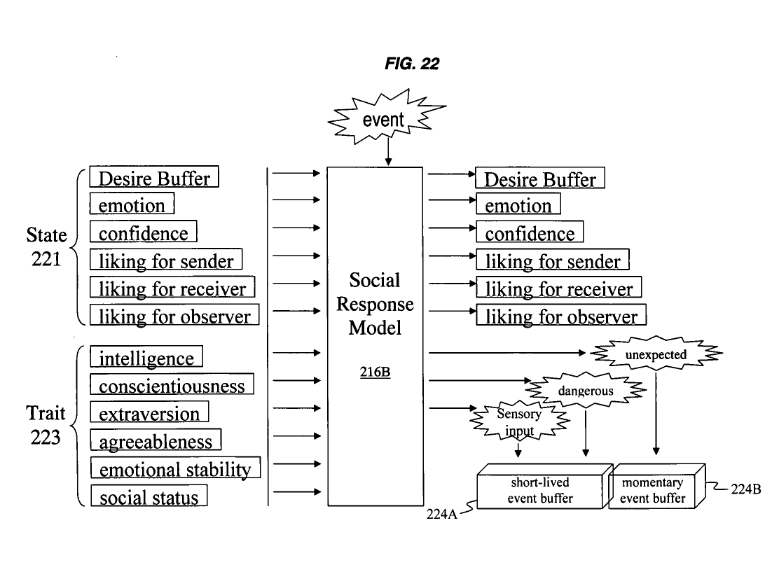

The social response model 216B has a set of rules for handling each detected event 212B. An example of implementation of the social response model is depicted in FIG. 22. In this example, traits 223 consist of intelligence value, conscientiousness value, extraversion value, agreeableness value, emotional stability value, and social status value for every agent in the virtual environment. The states, 211, of each agent consist of the emotion value, confidence value, liking values for every agent in the virtual environment, a desired behavior buffer for maintaining desire, and event buffers for maintaining emotional event named short-lived emotional event buffer and momentary emotional event buffer. These states are updated by the social response model 216B when each agent receives social events from the virtual environment.

Notably, in this example each rule in the social response model 216B is created specifically for the particular agent to determine how to update values in the states, and how to put/remove desires and emotional events to/from buffers in states. On the other hand, according to another embodiment, each rule in the social response model 216B is created to be common for all of the agents. Of course, when a common rule is invoked for any particular agent, it can have different values of traits and/or states for the specific agent. Regardless of which implementation is chosen, each value in the states 211B and traits 213B are used by application developers to specify the behaviors of the agents. Each desire stored in the desired buffer 217B is used for triggering specific behavior of the agents corresponding to specified conditions that must be met. In this example, desires are employed for providing social feedback, i.e., emotion 215B. Because the response model 205B maintains and updates the values of the dynamic and static buffers, 211B and 213B, and the desire buffer 217B, it is not necessary for developers of applications to know how these values and buffer should be maintained and updated. Therefore, it makes it easier for developers of applications to add emotional behavior to agents in the application.

In the example of FIG. 22, three types of inputs are used to update the event buffer 224, i.e., short-lived event buffer and momentary event buffer. These are sensory input event, dangerous event, and unexpected event. Sensory input event and dangerous event are maintained in the short-lived emotional event buffer 224A, and unexpected event is maintained in momentary emotional event buffer 224B. Each emotional event stored in the event buffer 214 is used in categorical emotion model 218B.

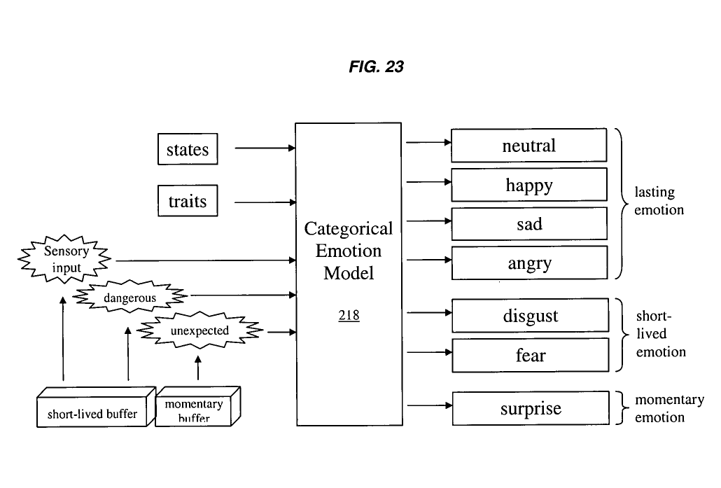

The categorical emotion model 218B is a mechanism for generating categorical emotions of agents referencing their states, traits, and event buffers. An example of the categorical emotion model is depicted in FIG. 23. In the categorical emotion model 218B, seven types of emotions are classified in three categories: lasting emotions, short-lived emotions, and momentary emotions. Lasting emotions consist of happiness, sadness, anger, and neutral. These emotions are delivered from the emotion value in the states and the agreeableness value in traits. Short-lived emotions consist of fear and disgust. These emotions are delivered from liking values in states and emotional events in the short-lived emotional event buffer. Momentary emotions consist of surprise. These emotions are delivered from emotional events in the momentary emotional event buffer. The emotions in the category of lasting emotions are the emotions which have a continuing duration based on events and emotions in the last moment. The emotions in the category of short-lived emotions are the emotions which last as long as the sources of the emotions remain active. Short-lived emotions have priority over lasting emotions and the output decision of the categorical emotion model would select a short lived emotion over a lasting emotion. The emotions in the category of momentary emotions are the emotions which are expressed only a moment after the sources of the emotions emerge, and then terminated. Momentary emotions have priority over short-lived and lasting emotions, and the output decision of the categorical emotion model would select a short lived emotion over a lasting emotion or a short-lived emotion. According to these rules, any conflict between emotions can be resolved and the proper expression and behavior of the agent can be properly controlled.

A general example of a computer (not shown) that can be used in accordance with the described embodiment will be described below.

The computer comprises one or more processors or processing units, a system memory and a bus that couples various system components comprising the system memory to processors. The bus can be one or more of any of several types of bus structures, comprising a memory bus or memory controller, a peripheral bus, an accelerated graphics port and a processor or local bus using any of a variety of bus architectures. The system memory comprises read only memory (ROM) and random access memory 140. A basic input/output system (BIOS) containing the routines that help to transfer information between elements within the computer, such as during boot up, is stored in the ROM or in a separate memory.

The computer further comprises a hard drive for reading from and writing to one or more hard disks (not shown). Some computers can comprise a magnetic disk drive for reading from and writing to a removable magnetic disk and an optical disk drive for reading from or writing to a removable optical disk, such as a CD ROM or other optical media. The hard drive, the magnetic disk drive and the optical disk drive are connected to the bus by an appropriate interface. The drives and their associated computer-readable media provide nonvolatile storage of computer-readable instructions, data structures, program modules and other data for the computer. Although the exemplary environment described herein employs a hard disk, a removable magnetic disk and a removable optical disk, it should be appreciated by those skilled in the art that other types of computer-readable media which can store data that is accessible by a computer, such as magnetic cassettes, flash memory cards, digital video disks, random access memories (RAMs), read only memories (ROMs), etc. may also be used in the exemplary operating environment.

A number of program modules may be stored on the hard disk, magnetic disk, optical disk, ROM or RAM, comprising an operating system, at least one or more application programs, other program modules and program data. In some computers, a user might enter commands and information into the computer through input devices such as a keyboard and a pointing device. Other input devices (not shown) may comprise a microphone, a joystick, a game pad, a satellite dish and/or a scanner. In some instances, however, a computer might not have these types of input devices. These and other input devices are connected to the processing unit through an interface coupled to the bus. In some computers, a monitor or other type of display device might also connected to the bus via an interface, such as a video adapter. Some computers, however, do not have these types of display devices. In addition to the monitor, the computers might comprise other peripheral output devices (not shown) such as speakers and printers.

The computer can, but need not, operate in a networked environment using logical connections to one or more remote computers, such as a remote computer. The remote computer may be another personal computer, a server, a router, a network PC, a peer device or other common network node, and typically comprises many or all of the elements described above relative to the computer. The logical connections to the computer may comprise a local area network (LAN) and a wide area network (WAN). Such networking environments are commonplace in offices, enterprise-wide computer networks, intranets, and the Internet.

When used in a LAN networking environment, the computer is connected to the local network through a network interface or adapter. When used in a WAN networking environment, the computer typically comprises a modem or other means for establishing communications over the wide area network, such as the Internet. The modem, which may be internal or external, is connected to the bus via a serial port interface. In a networked environment, program modules depicted relative to the computer, or portions thereof, may be stored in the remote memory storage device. It will be appreciated that the network connections shown are exemplary and other means of establishing a communications link between the computers may be used.

Generally, the data processors of the computer are programmed by means of instructions stored at different times in the various computer-readable storage media of the computer. Programs and operating systems are typically distributed, for example, on floppy disks or CD-ROMs. From there, they are installed or loaded into the secondary memory of the computer. At execution, they are loaded at least partially into the computer's primary electronic memory. The invention described herein comprises these and other various types of computer-readable storage media when such media contain instructions or programs for implementing the steps described below in conjunction with a microprocessor or other data processor. The invention also comprises the computer itself when programmed according to the methods and techniques described below.

The foregoing description of the preferred and other embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

Thus, while only certain embodiments of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. An article of manufacture, which comprises a computer readable medium having stored therein a computer program for socially intelligent agent platform for providing social behavior of agents interacting with an application coupled to the platform in a virtual environment, the computer program comprising:
a first code portion which, when executed on a computer, generates at least one socially intelligent agent (SIA), said SIA outputting behavior signals in response to received event signals;
a second code portion which, when executed on a computer, generates a virtual environment, said virtual environment facilitating communication among socially intelligent agents created by said first code portion;
a third code portion which, when executed on a computer, forms an adapter facilitating transfer of data between said virtual environment and said application, said adapter further receiving event signals from the application and transferring the event signals to the virtual environment, and receiving agent behavior response from the virtual environment and transferring the behavior response to the application.

2. The article of manufacture according to claim 1, wherein said communication comprises application specific events.

3. The article of manufacture according to claim 1, wherein the communication comprises a task identifier, a task source, and a task destination.

4. The article of manufacture according to claim 2, further comprising a fourth code portion which, when executed on a computer, forms an event interpreter, said event interpreter receiving said specific events and issuing a corresponding common event.

5. The article of manufacture according to claim 1, wherein each SIA comprises: a static register, a dynamic register, and a response model.

6. The article of manufacture according to claim 5, wherein upon receiving a communication, the SIA's response model is operated to update the dynamic register.

7. The article of manufacture according to claim 6, when the response model receive an event signal, the response model queries the static and dynamic registers and outputs a corresponding response signal.

8. The article of manufacture according to claim 7, wherein the response model further determines the validity duration of said response signal.

9. The article of manufacture according to claim 4, wherein the event interpreter further determines the validity duration of a response signal to be sent to said application.

10. A socially intelligent agent (SIA) platform, structured for interactions with a plurality of applications having a plurality of actors, for injecting socially intelligent response to said actors, comprising:
an interface for receiving application data and event signals from said application and sending agent responses to said applications;
a socially intelligent agent generator that generate an SIA corresponding to each actor of said applications, each of said SIA comprising:
a dynamic register;
a static register;
a response model programmed to, in response to receiving an application event, update the dynamic register and to output an agent response based on at least one of the outputs of the dynamic register or the static register; and,
a virtual environment engine transferring event signals and event feedbacks among socially intelligent agents generated by the SIA generator.

11. The SIA platform according to claim 10, further comprising an event buffer, and wherein said event buffer stores indication of the validity duration of each event.

12. The SIA platform according to claim 11, wherein the event buffer comprises at least a momentary time duration, a sort time duration and an indefinite time duration.

13. The SIA platform according to claim 12, wherein the response model checks the event buffer to determine the duration of the agent response.

14. The SIA platform according to claim 10, further comprising a context generator, said context generator receiving said application data and maintaining a set of rules defining the object and the process flow of the application.

15. The SIA platform according to claim 10, further comprising a future action buffer storing actions to be taken upon occurrence of specified conditions.

16. The SIA platform according to claim 10, wherein said response model comprises an event interpreter and an output generator, wherein said event interpreter receives application events and issuing corresponding common events, and wherein said output generator receives said common events and updates said dynamic register in response to said common events.

17. The SIA platform according to claim 16, further comprising a future action buffer storing actions to be taken upon occurrence of specified conditions, and wherein said event interpreter updates said future action buffer.

18. A socially intelligent agent (SIA) platform, structured for interactions with a plurality of applications having a plurality of actors, for injecting socially intelligent response to said actors, comprising:
a socially intelligent agent generator that generate an SIA corresponding to each actor of said applications, each of said SIA comprising:
an event interpreter receiving application events from the application and converting the application events into common events;
a dynamic register;
a static register;
a duration buffer storing validity period of an agent response;
an output generator receiving said common events from said interpreter and updating the dynamic register in accordance with the common event and the duration buffer;
wherein upon updating of said dynamic register said SIA outputs a response messages based on at least one of the static and dynamic registers and the duration buffer.

19. The SIA platform according to claim 18, further comprising an application adapter, said application adapter receiving event signals from the application and transferring the event signals to the SIA, and receiving the response messages from the SIA and transferring the response messages to the application.

20. The SIA platform according to claim 19, wherein said duration buffer comprises at least a momentary time duration, a sort time duration and an indefinite time duration.

21. The SIA platform according to claim 18, further comprising a future action buffer storing actions to be taken upon occurrence of specified conditions, and wherein said event interpreter updates said future action buffer.
